(19) United States
(12) Patent Application Publication
(10) Pub. No.: US 2026/0112080 A1
(43) Pub. Date: Apr. 23, 2026

(54) ACTIVITY-BASED ALERT GENERATION FROM WI-FI SIGNALS

(71) Applicant: DISH Network Technologies India Private Limited, Bengaluru (IN)

(72) Inventors: Arun Pulasseri Kalam, Bangalore (IN); Rajesh Govindu, Bangalore (IN); Mansoor Ahmed, Bangalore (IN); Prasanna Kumar L, Chikkaballapur (IN)

(21) Appl. No.: 18/975,933

(22) Filed: Dec. 10, 2024

(30) Foreign Application Priority Data
Oct. 18, 2024 (IN) 202441079404

(51) Int. Cl. G06T 11/20; G01S 13/89; G06F 18/23

(52) U.S. Cl. CPC G06T 11/26; G01S 13/89; G06F 18/23

(57) ABSTRACT

A method for detecting behaviors may include receiving, by a computing system, wireless data may include phase data and amplitude data over a time period. The method may include generating, by an image generation module of a computing system, a first image using at least one of the phase data or the amplitude data of the wireless data, where the first image represents an object during the time period. The method may include determining, by a machine learning module implemented on the computing system, a first current behavior of the object based on the first image. The method may include transmitting, by the computing system, a message to a user device, the message indicating the first current behavior of the object.

### CROSS REFERENCE TO RELATED APPLICATIONS

This application claims priority to Indian Provisional Patent Application No. 202441079404 filed on Oct. 18, 2024, in the Indian Intellectual Property Office, the disclosure of which is incorporated by reference in its entirety for all purposes.

### BACKGROUND OF THE INVENTION

The proliferation of wireless technologies has significantly transformed the landscape of connectivity, particularly through the widespread deployment of Wi-Fi technology. This transformation has facilitated the emergence and integration of various Wi-Fi devices and smart technologies into our daily lives, enabling unprecedented levels of automation and convenience. Further, traditional activity monitoring methods, such as video surveillance, often face pushback due to privacy concerns, underscoring the need for non-intrusive alternatives. Thus, improved methods and techniques are required which can increase accuracy of Wi-Fi based detection in existing and upcoming Wi-Fi systems. Additionally, the Wi-Fi systems require contextual awareness of Wi-Fi based detection, particularly in mesh Wi-Fi systems.

### BRIEF SUMMARY OF THE INVENTION

A system may include an image generation module. The system may include a machine learning module. The system may include one or more processors. The system may include a non-transitory computer readable medium may include instructions that, when executed by the one or more processors, cause the system to perform operations. According to the instructions, the system may receive, by a computing system, wireless data may include phase data and amplitude data over a time period. The system may generate, by an image generation module of a computing system, a first image using at least one of the phase data or the amplitude data of the wireless data, where the first image represents an object during the time period. The system may determine, by a machine learning module implemented on the computing system, a first current behavior of the object based on the first image. The system may transmit, by the computing system, a message to a user device, the message indicating the first current behavior of the object.

In some embodiments, the system may include one or more satellite nodes, each configured to transmit and/or collect wireless data. The system may include a central node, the central node configured to receive the wireless data from the one or more satellite nodes, and where the machine learning module is implemented on the central node. Each of the one or more satellite nodes may be configured to generate image data based on respective wireless data received at the one or more satellite nodes. Each of the satellite nodes may include a respective image generator and respective machine learning module. The machine learning module may include at least one of a k-nearest neighbor model, a clustering model, and a computer vision model. The image generation module may utilize continuous wavelet transformation.

A method for detecting behaviors may include receiving, by a computing system, wireless data may include phase data and amplitude data over a time period. The method may include generating, by an image generation module of a computing system, a first image using at least one of the phase data or the amplitude data of the wireless data, where the first image represents an object during the time period. The method may include determining, by a machine learning module implemented on the computing system, a first current behavior of the object based on the first image. The method may include transmitting, by the computing system, a message to a user device, the message indicating the first current behavior of the object.

In some embodiments, the first current behavior of the object may be at least one of one of sitting, standing, walking, running, moving, laying down. The method may include applying a continuous wavelet transformation to the wireless data. The method may include receiving, by the computing system and from the user device, a request for the first current behavior of the object and determining, by the computing system, a particular device of the computing system within a given proximity of the object. The method may include determining, by the computing system, that the first current behavior is an unwanted behavior. The method may include transmitting, by the computing system, an emergency message to an emergency service.

In some embodiments, the method may include determining, by the computing system, a location of the object based at least in part on a node of the computing system. The second image may represent the object during the time period. The method may include determining, by the machine learning module implemented on the computing system, a second current behavior of the object based on the second image. The method may include comparing, by the computing system, the first current behavior and the second current behavior to generate a confidence metric. The wireless data may correspond to a first frequency and the additional wireless data corresponds to a second frequency. The second image represents the object during the time period. The method may include determining, by the machine learning module implemented on the computing system, a second current behavior of the object based on the second image. The method may include comparing, by the computing system, the first current behavior and the second current behavior to generate a confidence metric. The message is transmitted to the user device in response to the confidence metric being over a predetermined threshold. The method may include providing, by the computing system, one or more data sets may include phase data and/or amplitude data corresponding to one or more particular behaviors to the machine learning module. The method may include causing, by the computing system, one or more machine learning models of the machine learning module to be retrained using the one or more data sets.

A computer-readable medium may include instructions that, when executed by one or more processors, cause the one or more processors to perform operations. The operations may include receiving, by a computing system, wireless data may include phase data and amplitude data over a time period. The operations may include generating, by an image generation module of a computing system, a first image using at least one of the phase data or the amplitude data of the wireless data, where the first image represents an object during the time period. The operations may include determining, by a machine learning module implemented on the computing system, a first current behavior of the object based on the first image. The operations may include transmitting, by the computing system, a message to a user device, the message indicating the first current behavior of the object.

In some embodiments, the image generation module may utilize continuous wavelet transformation. The second image may represent the object during the time period. The operation may include determining, by the machine learning module, a second current behavior of the object based on the second image and comparing, by the computing system, the first current behavior and the second current behavior to generate a confidence metric.

### BRIEF DESCRIPTION OF THE DRAWINGS

FIG. 1 is an example system and process which may be used for detecting activities using wireless signals according to aspects of the disclosed technology.

FIGS. 2A-2F various aspects related to detection through wireless signals according to aspects of the disclosed technology.

FIG. 3 relates to a training process of a machine learning algorithm according to aspects of the disclosed technology.

FIG. 4 depicts an example method according to aspects of the disclosed technology.

FIG. 5 depicts example experimental results according to aspects of the disclosed technology.

FIG. 6 depicts an example computer system according to aspects of the disclosed technology.

### DETAILED DESCRIPTION OF THE INVENTION

### Overview

Mesh wireless networks may contain one or more wireless transmitters, receivers, or transceivers, that each may be referred to as a node or a wireless node. The wireless network may also contain one or more computing devices (e.g., user devices) that may be in data communication with the one or more wireless nodes. Further, each wireless node may communicate amongst and between other nodes within the wireless network. The interconnected network of computing devices and wireless nodes may be referred to as a mesh wireless network. Each node may transmit and/or receive a wireless signal (e.g., a Wi-Fi signal) to allow for communication and/or other functionality on the wireless network.

One or more wireless signals may be used to determine one or more behaviors (which may also be referred to as events, actions, activities, motion, etc.) of an object (also referred to as a subject) within an environment. Classification techniques, including but not limited to trained machine learning models, may be used to classify the object and/or the behavior of the object. The classification of the object may cause a message to be transmitted to one or more devices. The message may be configured to cause one or more actions to be undertaken based on the configuration, content, and/or source of the message (e.g., which wireless node was used as the source of the wireless signal that was used to determine the classification).

Classification of an object may be performed using based on one or more characteristics of a wireless signal. Each wireless signal may have various characteristics, including encoding, wireless protocol used, as well as physical components, such as frequency, phase, amplitude, waveform, etc. As further explained below, the amplitude information of a wireless signal may be used to make a first classification and the phase information of that same wireless signal may be used to make a second classification. The second classification may be made independently of the first classification such that each classification is mathematically independent of the other classification. In this manner, a single wireless signal can provide two classifications.

Similarly, an additional wireless signal (e.g., one which may be received at a different wireless node from the first wireless signal, or a wireless signal received at the same node with a different frequency (e.g., a 2.4 Ghz signal and a 5 Ghz signal) may be analyzed to provide two classifications of an event. Thus, in various configurations and/or permutations of a mesh network (e.g., a number of nodes, number and/or types of wireless signals received), varying number of classifications may be achieved. For example, a single node can provide four classifications (e.g., receiving wireless signals at two frequencies) classifications; two nodes can provide four classifications (e.g., a wireless signal with one frequency at each node) or eight classifications (e.g., two frequencies received at each node).

Prior to analysis, the wireless signal may be transformed to improve classification accuracy, speed, and/or reduce complexity of the classification task. In some embodiments, a continuous wavelet transform (CWT) may be applied to a wireless signal.

A central node of the mesh wireless network may receive wireless data from satellite nodes of the mesh wireless network. The central node may perform the classification and/or aggregate classifications performed by the satellite nodes. The central node may provide alerts, indications, or messages based on the classifications.

Yet, in practice, the usefulness of the above classifications is limited by existing techniques for detecting or classifying motion using wireless signals (e.g., Wi-Fi signals or Wi-Fi networks), that are limited in several regards. Existing techniques rely on specialized hardware setups or configurations. Further, these techniques are based on the use of specific channels of a transmitter or a receiver. Thus, they may not be generalized to be used on any hardware which may have a transmitter and a receiver. Additionally, the specialized hardware and/or setup requires specialized machine learning models which are only applicable or configured for that hardware. Thus, for example, these existing techniques cannot leverage mesh networks which have multiple nodes to transmit and/or receive wireless signals.

Existing techniques may combine multiple parts of a received wireless signal, such as phase information and amplitude information, in specific ways (e.g, specific weights) to generate a combined signal. The combined signal may be analyzed for detecting motion. Existing techniques also use specific preprocessing or filtering of signals prior to analysis. For example, the existing techniques may also on principal component analysis (PCA) for evaluating the components of the combined signal. The specificity required by these techniques limit the generalized use of wireless transmitters and receivers for Wi-Fi sensing. Additionally, after receipt of the signal, the accuracy of the detection and/or classification is limited. For example, and as further explained herein, the use of Digital Wavelet Transformation (DWT) techniques in existing methods limits the accuracy which may be obtained.

These limitations, and enablement of various functionalities by Wi-Fi sensing may be made possible by the disclosed technology.

The disclosed technology may include a system for detecting motion and/or activities within an environment through the utilization of wireless signals, including Wi-Fi signals. Aspects of this technology include capturing Wi-Fi signal reflections, altered by motion within a specified area. The disclosed technology may process wireless signals using Continuous Wavelet Transformation (CWT) to isolate signal characteristics indicative of various activities. A subsequent step may involve the classification of these activities via a machine learning algorithm, tailored to identify specific movements or presence within the environment. This technology may be integrated with existing Wi-Fi infrastructure, offering a solution that is both non-invasive and respectful of privacy concerns. The technology may span multiple settings, from residential to healthcare.

In at least some embodiments, a Wi-Fi sensing system may employ Continuous Wavelet Transformation (CWT). CWT is a method or technique that represents a departure from Digital Wavelet Transformation (DWT) based methods. Compared to existing techniques, relying on DWT, CWT provides higher accuracy, reliability, and potential to integrate wireless signal (e.g., Wi-Fi based) detection techniques with other techniques. Simultaneously, CWT techniques are useful and quick enough to allow for a high frequency wireless signal (e.g., a Wi-Fi signal) to be processed and for classification to occur in real-time.

Further features of the disclosed technology include its ability to operate in real-time, providing feedback and alerts based on detected activities. This capability is important for applications requiring timely responses, such as security systems in smart homes or patient monitoring in healthcare settings. Additionally, the system's design allows for dynamic adaptation to the specific characteristics of the environment, enhancing detection accuracy and minimizing false positives.

The incorporation of a user interface may enable customization of detection parameters and review of activity logs, offering users control and insight into the system's operation. Through the integration of advanced signal processing and machine learning, the technology may detect and learns from the environment, improving its functionality over time.

The technology also includes a feedback mechanism to enhance user engagement and system accuracy. By allowing users to provide input on activity detection accuracy, the system can fine-tune its algorithms, ensuring continuous improvement over time.

In overview, the disclosed technology allows for detection of a transmitted signal which has been modified or altered by the presence of a subject. This altered signal is referred to as the modified wireless signal or the altered wireless signal. The altered wireless signal can be received at a receiver. The modified wireless signal can be analyzed using CWT techniques to generate data. The generated data may be amplitude data and/or phase data. A scalogram can be generated from the generated data from amplitude data alone or from phase data alone. The scalogram can be analyzed using a machine learning model to determine the subject, the action taken by the subject, and/or an object which may be modifying the altered signal. Amplitude data and phase data may be CSI based amplitude data and CSI based phase data, respectively.

As an example, of a use case of the disclosed technology, a house may contain multiple rooms, which may each be considered to be a separate environment. A mesh wireless network may be established within the house with multiple satellite nodes and a central node. One or more of the environments may contain a wireless node (e.g., a transmitter, receiver, or transceiver). The house may also have one or more subjects which may be expected to be moving through the house (e.g., children, adults, pets, robots, smart devices, etc.). The mesh network and/or the central node may be connected to one or more user devices within the house. As subjects move through the house, the wireless signals may be perturbed, and received by the nodes of the wireless network. The perturbations may be received by the nodes of the wireless network. These perturbed wireless signals (also referred to herein as modified wireless signals) may be analyzed to classify and/or determine the subject and the behavior thereof.

The central node or a central computer system of the mesh network may contain rules and/or configurations on when to perform the classifications. For example, a rule may exist which indicates that classifications within a particular environment (e.g., the hallway) should be performed. The rule may indicate the type of classification or the granularity of the classification. For instance, the rule may indicate whether to check for any motion at all after midnight for security reasons near the entrance doors of the home. The rule may also indicate to check for motion of a pet periodically (e.g., every hour) and to determine where the pet may be located. The rule may be modified for certain subjects based on user requirements (e.g., only checking for classifications of “falling” or “laying down” for an elderly user). Similarly, those rules may be established for certain nodes (e.g., a wireless node near a bathroom or other wet area may be set to perform classifications of “falling down” but not other classifications). Classifications may be performed by multiple nodes to improve accuracy of the classification. CWT transformation may be performed on the wireless data.

Messages and/or alerts may be transmitted based on the classifications. For example, the central node may determine which user devices to transmit an alert to. Emergency messages may be transmitted to emergency services for certain classifications (e.g., falling down, transitioning to a motionless state, etc.). Further, a user may transmit a request to the mesh network to perform a classification to identify what is happening in his or her home environment, allowing insight into the environment even when the user is not present.

### Example Systems and Methods

The following examples illustrate various embodiments of the disclosed technology, aligned with the figures previously described, offering a detailed view of how the system operates within various settings.

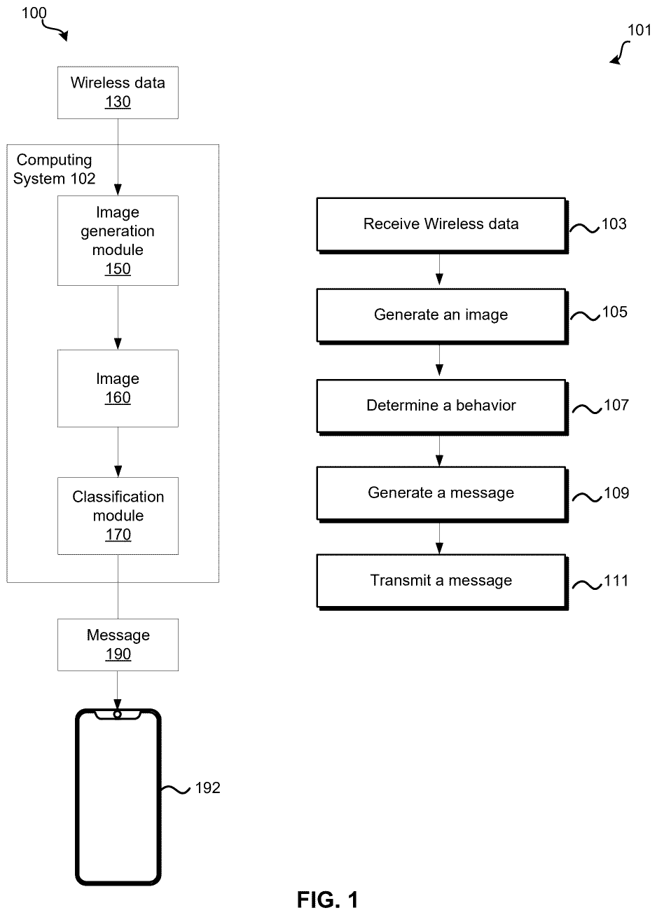

FIG. 1 illustrates a system 100 and a process 101 related to generating alerts based on detection of activity, motion, events, and/or occurrences within an environment, according to certain embodiments. In broad overview, the system 100 may allow for a wireless data 130 to be received, and for a message 190 to be transmitted to a user device 192.

Turning first to the system 100 that may include a computing system 102 and a user device 192. The system 100 may be and/or form a portion of a mesh wireless network. The mesh wireless network may comprise any number of wireless receivers, wireless transmitters, and connected computing devices (e.g., laptops, mobile devices, smartphones, tablets, etc.). The computing system 102 may be a single device or a combination of devices which may transmit, receive, and/or process wireless information. The computing system 102 may additionally have other components not illustrated in FIG. 1, such as for example, a receiver, a transmitter, communication components, etc. The computing system 102 may be similar to the computer system 600.

The wireless data 130 may be a wireless signal (e.g., a Wi-Fi signal) which may be received at the computing system 102, which may be digitized by the computing system 102. In some embodiments, the wireless data 130 may be data transmitted from another node within the wireless mesh network (e.g., data which may have been obtained, transformed, and/or digitized) at another node. Additional aspects of the wireless data 130 are discussed further below.

The image generation module 150 of the computing system 102 may include hardware and/or software which is capable of generating images based on information of data obtained from the wireless circuitry 140. For example, the image generation module 150 may contain the capability to generate one or more visual representations of wireless data such as scalograms. A scalogram may be a visual representation of a signal's frequency content over time, created using wavelet transforms. In some examples, the image generation module 150 can provide information which can relate to its output, such as the inability to produce an image based on the information which has been received by the image generation module 150. A person of skill in the art will appreciate that other equivalent representations of a scalogram may be outputted by the image generation module.

The classification module 170 of the computing system 102 may contain hardware and/or software to perform classifications. In some examples, the classification module 170 may contain one or more machine learning models (MLMs), rules-based filters, and other such components. The classification module 170 may contain algorithms including decision trees, random forest decision trees, logistic regression, support vector machines, naïve bayes, k-nearest neighbors, neural networks, gradient boosting machines, etc. Additional examples of the image generation module 150 and the classification module 170 may be provided below. A message 190 may be generated from the computing system 102. The message 190 may be generated based on a classification output by the classification module 170. In some examples, the message 190 may be based on the specific node from which the wireless signal (or wireless information) being classified was obtained. For example, if the specific node is in a bathroom, and a “falling” classification has been generated, the message may be encoded to be an emergency message as the message 190. However, if the specific node was in a play area of the house, and a “falling” classification was generated, a lower priority alert message may be generated as the message 190.

The user device 192 may be any device which is capable of receiving and transmitting messages, such as for example, a mobile device, a smart phone, a laptop, an loT device, a set top box, another computing device, a server device, etc. The user device 192 may receive a message 190 from the computing system 102. The user device 102 and/or the message 190 may be configured to take actions responsive to the receipt of the message, such as for example, generating an alert, alerting emergency services, causing an indication to be displayed on one or more devices connected with the mesh network, transmitting an alert to emergency services, causing a prompt to be displayed by an application on the user device requesting an input, or causing additional classifications to be undertaken.

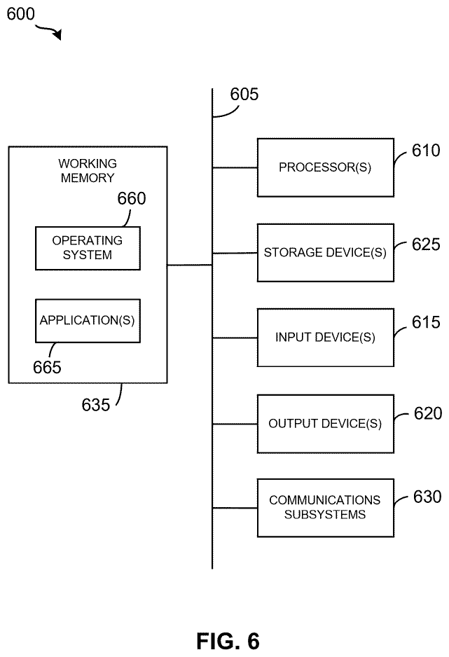

The computing system 102 may be distributed across multiple devices. The computing system 102 may contain any of the components described below with respect to FIG. 6. The computing system 102 may contain a receiver and circuitry to process signals, data, images, or other information, whether analog or digital. The circuitry of the computing system 102 may include any of the following non-limiting components. The components discussed are exemplary and a person of skill in the art will appreciate that other variations are within the scope of the disclosed invention. An antenna may be configured or designed to capture electromagnetic waves at different frequency bands. For example, the router may be configured for 2.4 gigahertz (GhZ) or a 5 GhZ frequency bands. Filters and amplifiers may be included in the receiver 130 or the wireless circuitry 140. A downconverter may be included to transform the high-frequency signal into a lower frequency which may be more suitable to process. After down conversion, a demodulator may take the signal generated from the antenna and extract data by reversing the modulation process which was used at the transmitter. An analog to digital convertor (ADC) may be used to convert analog signals to digital signals, which may be processed by a digital signal processor or other processor contained within the receiver 130. The wireless circuitry may also include other processors to perform any of the functions described herein.

Turning to the process 101, at 103, the computing system 102 may receive the wireless data 130. The wireless data 130 may be a wireless signal (e.g., a Wi-Fi signal) which may be received at the computing system 102, which may be digitized by the computing system 102. In some embodiments, the wireless data 130 may be data transmitted from another node within the wireless mesh network (e.g., data which may have been obtained, transformed, and/or digitized at another node). In some examples, a CWT transform may be applied to an analog and/or digital wireless signal to obtain a transformed signal which may be used to perform the analysis.

At 105, the image 160 may be generated by the image generation module 150. The image generation module 150 may output the image 160 (e.g., a scalogram) which may represent a portion of the wireless signal being analyzed (e.g., amplitude of the wireless signal or phase of the wireless signal). A scalogram may be thought of as a visual representation of a wavelet transform, having axes for time, scale, and coefficient value, analogous to a spectrogram. The scalogram may be generated by using coefficient values for amplitude, phase, or other properties of the wireless signal to generate a two dimensional scalogram image. Scalograms may also be referred to as wavelet periodograms. In some embodiments, multiple images (e.g., scalograms) may be generated which may each represent an aspect of the wireless signal (e.g., the amplitude, the phase, etc.). The image 160 may be based on a sampling over a fixed or predetermined period of time, over which a wireless signal is sampled.

At 107, the image 160 may be analyzed to determine the subject associated with the wireless signal and/or the behavior of the subject by the classification module 170. The classification module may determine the behavior of the object based on the characteristics of the image 160 generated by the image generation module 150. The classification module 170 may use rules-based filters to classify whether the image 160 should be analyzed by a machine learning module. For instance, the classification module 170 may receive information as part of the wireless data 130 which can identify the wireless node from which the wireless signal being classified was obtained. The classification module 170 may not perform certain types of classifications or not perform any classification based on characteristics of that wireless node (e.g., which room of a home it is placed in, whether it is in an industrial setting, the nature of the subjects within the home (e.g., children, pets, the elderly, etc.).

The classification module 170 may further use a machine learning module to classify the image 150 into one or more classifications. In some examples, the classification module 170 may suggest multiple classifications with a probability for that classification. For instance, the classification module 170 may be trained to have an output of “walking” “sitting” “standing” “jumping” etc. In some examples, the set of potential outputs may be modified based on user preferences, user information and/or the node from which the wireless information is obtained.

For instance, certain outputs may be included and/or excluded based on user preferences. A classification for “falling” may be included for a basement where it is known that only pets frequent, but the “falling” classification may be included for the stairs, walkways, and bathrooms. In some examples, a user may provide information about the environment and/or context in which the classifications are being performed to allow the classification module 170 to be modified.

At 109, the message 190 may be generated by the computing system 102. The message may be configured to cause one or more actions to be taken responsive to the receipt of the message. Exemplary actions may include a message indicating the classification with a visual (e.g., an icon indicating the location of the classification and/or the classification itself), causing a user interface and/or notification to be displayed on a user device (e.g., your dog is sleeping, someone is in the bedroom, someone entered the bathroom but has not exited, etc.), a request for a confirmation (e.g., it appears someone fell down, is everything ok?), or storing the message (and underlying classification/activity) on a user device to create summary statistics. The message may also be configured to cause emergency services and/or a trusted person to be contacted when a classification corresponds to an emergency condition (e.g., someone falling, not breathing, no detectable activity over a period of time).

At 111, the message may be transmitted from the computing system 102. The message may be transmitted from the computing system 102 one or more devices within the mesh network and/or a device external to the mesh network. The transmission may also be restricted to one or more user devices which are authorized to receive such classifications. The system may include Multiple user devices, each serving as a point for alert dissemination and interaction. For example, a TV may provide a visual platform for displaying alerts. A smart clock, may integrate time-based, audio, or other alerts into its functionality. A set-top box may act as a central hub for processing and transmitting alerts. A smartwatch may be used as a portable alert interface. A smartphone, allows for mobile receipt and acknowledgment of alerts. These devices may be used to generate alerts, provide indications, send messages, or take other steps. Other devices and mechanisms may be used. The message 190 may be modified and/or formatted to be suitable for each user device.

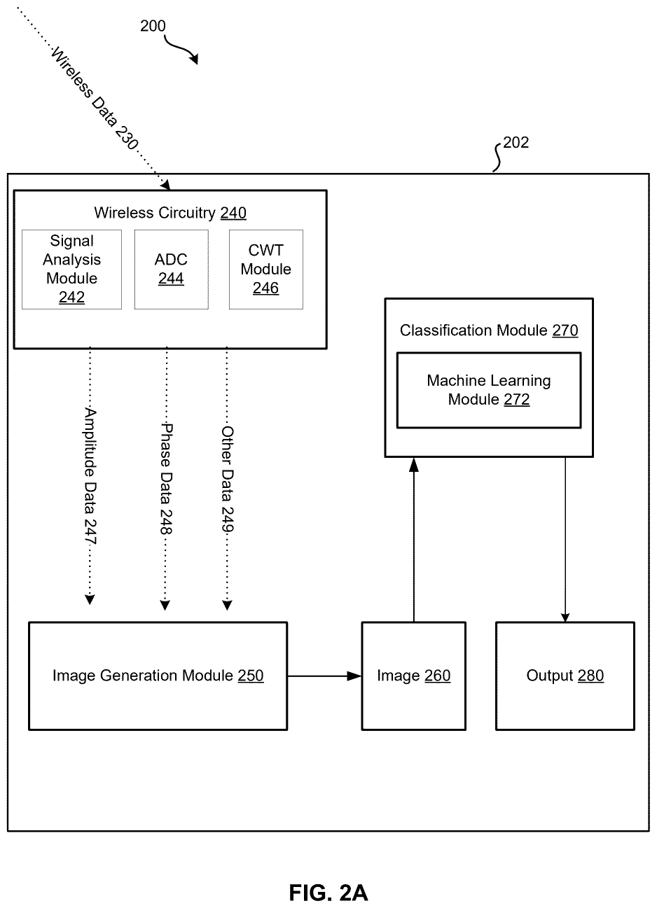

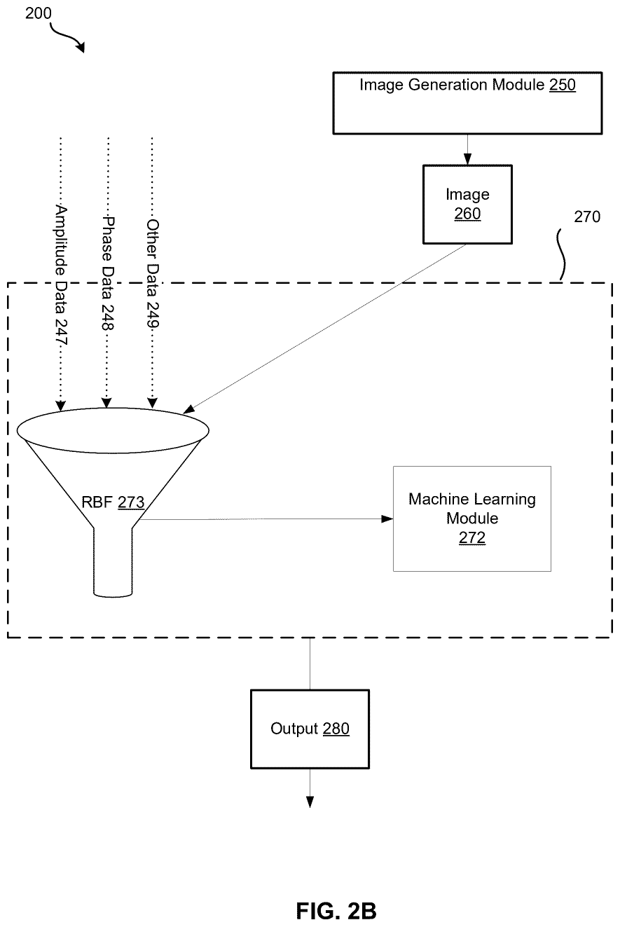

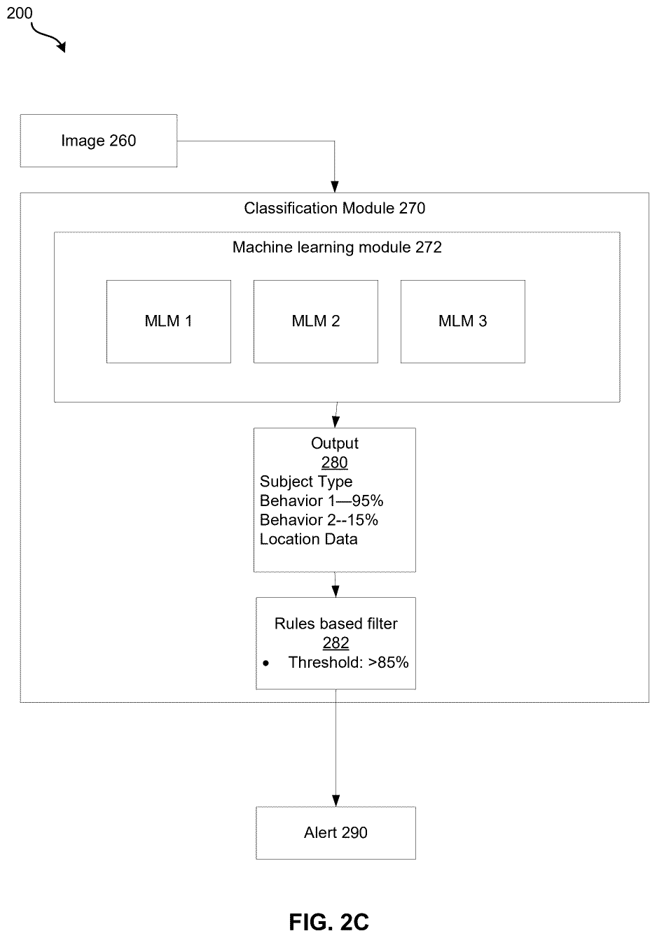

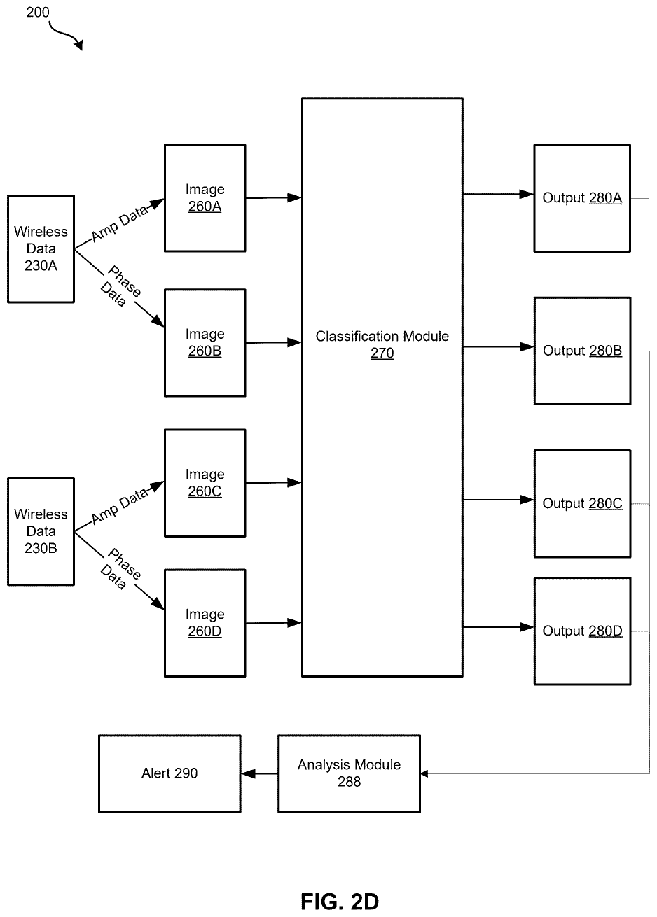

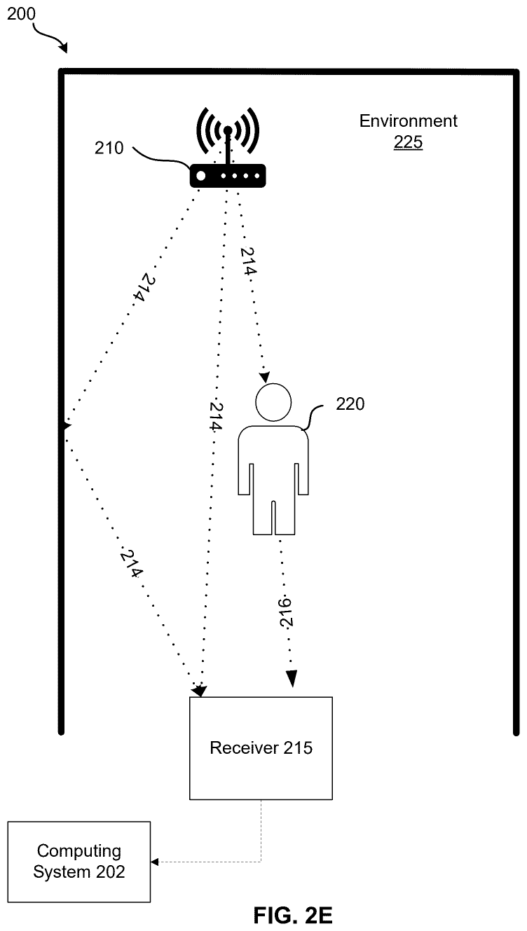

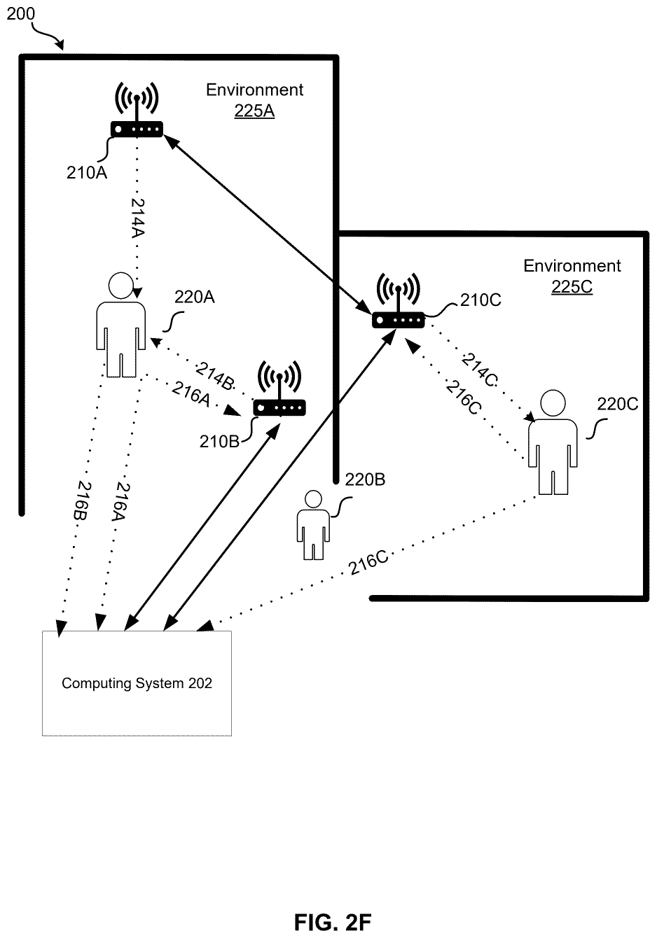

FIGS. 2A to 2F illustrate various embodiments of a system 200, which may include a computing system 202. As illustrated with and the applicability of techniques to perform classifications based on wireless data.

Referring to FIG. 2A, the computing system 202, or components thereof, are illustrated. The computing system 202 may include a wireless circuitry 240, an image generation module 250 capable of generating an image 260, and a classification module 270 which may generate an output 280. The computing system 202 may receive a wireless data 230, which may be similar to the wireless data 130 described above, or any other wireless signals described herein.

The wireless circuitry 240 may include a signal analysis module 242, an analog to digital convertor (ADC) 244, and a CWT module 246. The signal analysis module 242 may include hardware and/or software which may be responsible for examining the characteristics of incoming wireless signals (e.g., wireless data 230). The signal analysis module 242 may analyze various parameters of the signals such as strength, frequency, and quality. The signal analysis module 242 may ensure that the signals are within the desired specifications and may assist in identifying any anomalies or distortions that may affect communication. As one example, the signal analysis module 242 may generate or produce CSI data, which may be used by the system 200.

The analog to digital converter (ADC) 244 may convert analog signals received by the wireless circuitry 240 (e.g., those received by an antenna) into a digital format. The conversion may allow for further digital processing and analysis of the signals. The ADC 244 may ensure that the analog signals are accurately digitized, preserving their integrity and facilitating their subsequent manipulation and interpretation by the digital components of the wireless circuitry 240.

The Continuous Wavelet Transform (CWT) module 246 may process signals using wavelet transforms to analyze different frequency components at various scales. The CWT module 246 may identify and isolate specific features within a signal. The CWT module 244 enhances the ability to detect, interpret, and manage complex signal patterns, making the wireless circuitry more robust and efficient in handling diverse communication scenarios. In some examples, the CWT module 246 may process analog data (e.g., the wireless signal before the ADC). In some examples, the CWT module 246 may process digital data (e.g., data after conversion into a digital format by ADC 244). CWT may be applied to the CSI data (e.g., OFDM signal phase and amplitude) to understand the RF channel parameters.

Data may be processed by the CWT module 246 by using a using CWT transformation. CWT is an efficient transformation in determining the damping ratio of oscillating signals (e.g. identification of damping in dynamic systems). The Continuous Wavelet Transform (CWT) may provide a high localization in time and frequency by continuously varying the scale and translation (shifting) parameter of the wavelets. CWT may also be resistant to the noise in the signal. The wavelet transforms of a continuous time signal x (t) may be defined mathematically as below. The wavelet transform may be performed on digital data by discretizing the time values, and performing summations which are equivalent or approximate to the integral expression below.

$$X ( a , b ) = \frac{1}{\sqrt{\vert a \vert}} {\int }_{- ∞}^{∞} x ( t ) {ψ}^{*} ( \frac{t - b}{a} ) dt$$

Due to the high removal of noise by CWT, various pre-processing steps need to not be performed by the wireless circuitry 240. As one example, certain filters may not be used when generating data or information from one or more wireless signals. In some examples, other analysis techniques, such as principal component analysis, may not be used when generating or determining information from a wireless signal. The use of CWT may provide data which is low in noise and high in accuracy, which may later be used by one or more components of the wireless circuitry 240 to perform classification and/or provide an output 280. The output 280 may be configured to be provided as a message, similar to the message 190 described above with respect to FIG. 1.

The CWT module 246 may perform the analysis on more than one component, including on the amplitude and/or phase of the modified wireless signal 216 and/or the wireless signal 214. In some examples, the CWT module 246 may have multiple settings. As further explained below, the CWT module 246 may be configured to provide the best type of information to the classification module 270.

The wireless circuitry 240 may generate an amplitude data 247, a phase data 248, and an other data 249 in a digital and/or analog format. The amplitude data 247 may include information of the amplitude of one or more received signals over time. The phase data 248 may include information related to the phase of one or more received signals over time. Other data 249 may include other information related to encoding, transmission source, and/or transmission standard. Other data 249 may also indicate the wireless node from at which the wireless signal was received, and may be combined with other information indicating the type of environment that the wireless node is within (a bathroom, a living room, stairs, basement, apartment building, nursing home, showroom, etc). The wireless circuitry 240 may also distinguish between one or more of the signals received. For example, wireless circuitry 240 may distinguish between the modified wireless signal 216 and the wireless signal 214 (described further below with respect to FIG. E).

The image generation module 250 may take one or more sources of information provided by the wireless circuitry to generate images, such as the image 260. The image generation module 250 and the image 260 may be similar to the image generation module 150 and the image 160, described above with respect to FIG. 1, respectively. Although a description is provided herein with respect to images, a person of skill in the art will appreciate that alternative embodiments may be possible. The image generation module 250 may generate an image 260, which may be a scalogram. A scalogram is a visual representation of the magnitude of the coefficients obtained from a Continuous Wavelet Transform (CWT) of a signal, or other transformation techniques applied to a signal. The scalogram may be a two-dimensional plot that shows how the frequency content of the signal varies over time. The axes of the scalogram typically represent time and scale (or frequency), while the color or intensity at each point in the plot represents the magnitude of the wavelet coefficients at that specific time and scale. The coefficients may be for the phase and/or amplitude of the signal. The “X” axis or the horizontal axis of the scalogram may be represent a time or duration of a signal. The “Y” axis may represent the range of scales which are used in a wavelet transform. The “color” may represent the magnitude of a coefficient and/or value.

Image 260 may be generated based on the modified wireless signal 216. This signal may be modified based on activity of subject 220 and/or the presence of subject 220. This modified wireless signal may produce an image 260 which may represent a particular activity of subject 220. For example, an image 260 may have characteristics which represent a particular activity. These characteristics and/or features may be present in image 260, which may be analyzed by a machine learning model and/or a computer vision module, and may be visually represented on image 260 (e.g., particular patterns which represent sitting or standing on a scalogram).

The classification module 270, which may be similar to the classification module 170, may thus use the image 260 to classify and event. For example, in the case of Wi-Fi signals, classification module 270 may leverage machine learning algorithms to analyze the processed Wi-Fi signals. Classification module 270 may classify signals into predefined categories of human activities. For example, the classification module 270 module can distinguish between various types of movements and behaviors by comparing the signal characteristics isolated by CWT techniques against a dataset of activity patterns. The classification module 270 may be updated and adapted to increase its accuracy over time, enabling the system to provide precise activity detection and monitoring within the environment.

The machine learning module 272 may be included within the classification module 270. The classification module 270 may do so based on one or more algorithms and/or techniques. For example, classification module 270 may contain algorithms including one or more of a clustering model, decision trees, random forest decision trees, logistic regression models, support vector machines, naïve bayes models, k-nearest neighbors, neural networks, gradient boosting machines, etc.

As one example, the machine learning module 272 may contain a convolution neural network. Convolutional Neural Networks (CNNs) are a specialized kind of Deep Neural Networks. CNNs are composed of multiple layers that transform the input volume (such as an image) into an output volume (e.g., class scores) through a series of differentiable operations. The classification module 270 may take as an input, the image 260, and provide as an output, an output 280. The output 280 may be similar to the message 198 described above.

FIG. 2B illustrates additional aspects of system 200. The image generation module 250 may generate the image 260 which may be classified and/or analyzed by the classification module 270. Additionally, the classification module 270 may generate the output 280. Additional aspects of the classification module 270 are described below.

A rules-based filter (RBF) 273 may be a rule-based filters that applies specific criteria to classify images. These filters may use predefined rules, such as threshold values for certain features like color intensity, shape, or texture, to make initial classifications. In some examples, the rules-based filter 273 may receive other information from the wireless circuitry 240, including for example, an error message, a “low quality” indication, an indication of a threshold variation in the environment from which the wireless data 230 is obtained has not taken place, a “high noise” indication (e.g., when there is an indication that the image is too noisy), etc. This filter may be used to pre-filter images prior to providing classification. Additionally, as multiple images may be generated by the image generation module 250 over time, and as some events only occur for a few seconds at a time, pre-filtering through the rules-based filter 273 may allow for energy and/or computation efficiency savings. In some examples, the RBF 273 may also obtain the amplitude data 247, the phase data 248, and other data 249, and make determinations based on that. For example, if the amplitude data 247 is not sufficient, an image generated based on amplitude data may not be used for classification. As another example, if the RSSI received at a point of time is lower than a threshold value, the filter may reject that signal.

The RBF 273 may also filter out certain signals or types of patterns prior to analysis based on user inputs or preferences (e.g., whether the user indicates that he has young children and/or pets). The RBF may also filter out signals that are received from certain nodes and/or associated environments.

Machine learning module 272 may be a block that includes one or more machine learning models employed within the classification module 270. These models, which may include convolutional neural networks (CNNs), support vector machines (SVMs), and random forests, further refine the classifications. CNNs may be particularly effective for image classification tasks due to their ability to automatically detect important features within images. SVMs are useful for high-dimensional spaces and are effective when the number of dimensions exceeds the number of samples. Random forests, an ensemble learning method, operate by constructing a multitude of decision trees and outputting the class that is the mode of the classes of the individual trees.

The image 260 may have features or patterns that may be recognizable by a human cyc. Thus, a model that provides quick and easy classification may be used for certain types of activity detection. In these examples, a model that is computationally less intensive while providing higher accuracy is desirable. Thus, in some examples, the CNN model may include a variety of “light weight” models.

One example of such a “light weight” model is a CNN LeNet-5 model. The LeNet-5 model may use CWT to remove the noise from CSI data that is obtained. At a high level, LeNet (and/or LeNet-5) consists of two parts: (i) a convolutional encoder consisting of two convolutional layers; and (ii) a dense block consisting of three fully connected layers. The first layer convolution layer may apply or use one or more convolutional filters to the input data, capturing essential features and/or reducing dimensionality of data. The second convolution layer may further process the feature maps generated by the first layer, extracting more complex features. A dense block may consist of three fully connected layers. The first fully connected layer, that may take the output from the aforementioned convolution layers and may start to consolidate the features into a format suitable for classification. The second fully connected layer may further refine the data representation, enhancing the model's ability to distinguish between different classes. The third fully connected layer may finalize the data consolidation and produces an output classification. The output classification may be modified or adjusted based on other information to provide an output 280.

In some examples, the machine learning module 272 may include algorithms to allow for the selection of a model based on the hardware and/or software of the receiver 215. For example, specific MLMs may be configured or better tuned for specific types of receivers. For example, for a set top box (STB), a MLM model may be chosen such that the MLM may provide a classification within a set period of time (e.g., less than one second). In such cases, a model may be chosen based on the computational power and/or physical structure of a receiver within the STB. In such examples, the accuracy of the MLM may be reduced to allow for a “quick” classification. In other examples, such as when there is more processing power, a different model may be used that may provide higher accuracy or consider additional information when making a determination. In this manner, the machine learning module 272 may contain a variety of MLMs, that may be updated and selected based on the hardware and/or software of the receiver 240 in which the machine learning module 272 is located, stored, and/or instantiated.

As another example, a MLM stored on the machine learning module 272 may be adjusted based on the physical dimension of a wireless signal. For example, transmitter 210 may emit a 5 Ghz signal. The “resolution” for sensing for the 5 Ghz signal is roughly on the order of 6 centimeters. For a higher Ghz signal, a higher resolution can be achieved. In some examples, such as in dual-band Wi-Fi. For example, a transmitter 210 may transmit two signals at two frequencies (e.g., 2.4 Ghz and 5 Ghz). Each of the two signals may be received by the receiver 215. Information derived from the two signals at two different frequencies can be obtained. This information can allow for the validation of the analysis performed by each signal with respect to one another. A different MLM may trained and used for each frequency. These different models may be stored in the machine learning module 272. Each frequency may allow for a separate classification. This may allow for effects of interference patterns within an environment to be mitigated.

FIG. 2C illustrates additional aspects of system 200. Illustrated in FIG. 2C is the image 260, the classification module 270 including a machine learning module 272, the output 270, a rules based filter 282, and an alert 290. The image 260 may be provided to the classification module 270 to be classified as one of multiple behaviors. The machine learning module 272 may contain multiple machine learning models. One or more of the multiple machine learning models may be selected and provided the image 260 for classification. Three exemplary machine learning models (MLM 1, MLM 2, and MLM 3) are illustrated in machine learning module 272. The selection of one of the MLMs may be based on other contextual information regarding the classification (e.g., the accuracy required, the background/environment the MLM was trained for, the frequency range of the received wireless signal, the set of possible classifications which are enabled matched to the possible outputs from a specific MLM, the subject on which an MLM is trained (e.g., pets, children, adults), etc.). In this manner, one of the MLMs may be chosen to analyze the image 260.

The MLMs may provide the output 280. The output 280 may include the identified subject (e.g., a human, a pet, a child, or other non-living being (e.g., a robot vacuum etc.), one or more behaviors (e.g., behavior 1, behavior 2, etc.), and a probability that the behavior has occurred (95%, 15%, etc.). The output may also include information about location data (e.g., the location and/or environment in which the wireless signal analyzed was obtained). This information may be utilized in determining the content and/or characteristics of one or more messages generated based on the data.

The output 280 may be provided to a rules based filter (RBF) 282. The RBF 282 may have various criteria to filter out the output provided by the classification module 270 and/or the machine learning module 272 prior to allowing an alert 290 to be transmitted and/or outputted. For example, the RBF 282 may have an accuracy threshold requirement. In the example illustrated, only classifications which are above 85% may be outputted. Other rules may be included in the RBF 282. For example, differing accuracy requirements may be established in the RBF 282 for different types of behavior, different subjects, and/or different locations. In some examples, the output 280 may be confirmed by a second output (e.g., from another portion of the wireless data 230, such as the amplitude and/or the phase) prior to generating an alert. The RBF 282 may also differ and/or be adjusted for the environment in which the classifications are being performed.

The alert 290 may be similar to the message 190 described above with respect to FIG. 1. For example, the alert 290 may be may be configured to cause actions responsive to the receipt of the alert 290 to be undertaken (e.g., generating an alert, alerting emergency services, causing an indication to be displayed on one or more devices connected with the mesh network, transmitting an alert to emergency services, causing a prompt to be displayed by an application on the user device requesting an input, or causing additional classifications to be undertaken.)

FIG. 2D illustrates additional aspects of system 200, including the generation of multiple outputs from multiple wireless data. Illustrated in FIG. 2D are wireless data 230A and 230B, images 260A-260D, the classification module 270, outputs 280A-280D, analysis module 288, and the alert 290. The wireless data 230A and 230B may be similar to wireless signals described herein and wireless data 230. For example, wireless data 230A may correspond to a first wireless signal and wireless data 230B may correspond to a second wireless signal. The first wireless signal and the second wireless signal may be received at different wireless nodes of the mesh wireless network. The first signal and the second wireless signal may be received at the same receiver and/or wireless node but may correspond to two different frequencies (e.g., 2.4 GhZ, 5 GhZ, 6 GhZ etc.). One frequency may be extracted to generate the wireless data 230A and the other frequency may be extracted to generate the wireless data 230B.

The wireless data 230A and the wireless data 230B may contain at least amplitude information and phase information. This information may be extracted from the respective wireless data using any of the techniques described herein, including the CWT techniques. For each respective portion of the wireless data (amplitude data, phase data, or other data), a respective image may be generated. As illustrated, the amplitude data of the wireless signal 230A may generate the image 260A, the phase data of the wireless signal 230A may generate the image 260B, the amplitude data of the wireless signal 230B may generate the image 260C, the amplitude data of the wireless signal 230B may generate the image 260D. Each image may correspond to the same period in time for which the wireless signals are captured (or sampled through the CWT technique), in turn corresponding to the same behavior and/or activity to be detected. The images 260A-260D may all be similar to the image 260. Each image may provide an independent view of the behavior being performed, and may have “independent” mathematical probabilities. In this manner, classifications from each image may be cross-referenced.

The classification module 270 may analyze each of the images 260A-260D to generate outputs 280A-280D respectively. The outputs 280A-280D may contain similar information to the output 280. The outputs 280A-280D may contain an independent classification based on the respective image. This information may be provided to an analysis module 288. The analysis module 288 may contain various algorithms, criteria, and requirements based on which an alert 290 may be generated. For example, as each output may be mathematically (or probabilistically) independent of the other outputs, the probability of a certain classification may be confirmed by other outputs. For example, if output 280A suggests a 92% chance that the activity being detected is “getting up” and output 280B suggests a 96% chance that the activity being detected is “getting up,” those probabilities can be jointly analyzed by the analysis module 288 to generate a classification that is more accurate than either classification alone. Similarly, if one output suggests that the classification is unlikely (e.g., 20%), that output may be ignored if other outputs have a high probability of that classification.

The analysis module 288 may generate the alert 290 based on one or more included therein. The analysis module may also perform additional meta-analysis of the types of classifications it has received over time. For example, if it detects that a user has been sitting for a long period of time, it may suggest that the user may want to get up. As another example, if it detects that a pet has left the house but not returned by a set time (e.g., by dusk) it may provide configure the alert 290 to state that the pet has not returned.

FIG. 2E aspects of physical hardware and transmission of wireless signals within an environment. Illustrated in FIG. 2E is a transmitter 210 and a receiver 215 within an environment 225, including a subject 220. The transmitter 210 may generate a wireless signal 214, that may be modified by the subject 220, and/or reflected by the environment 225, to produce a modified wireless signal 216, that may be received by the receiver 215. The wireless signal 214 may be modified by the presence of the subject 220 to produce or create a modified wireless signal 216.

The receiver 215 may be in data communication with the computing system 202 (or a portion of the mesh network), enabling the computing system 202 to perform classifications based on the modified wireless signal 216. While illustrated as separate units, the transmitter 210 and the receiver 215 may be housed or contained within the same physical unit. For example, the transmitter 210 and the receiver 215 may both be a portion of a single wireless router, capable of both transmission of wireless signal and receipt of wireless signals.

Turning first to the environment 225. The environment 225 may be any type of environment where a wireless network may be provided. For example, the environment 225 may be a house, a room in a house, a hotel room, etc. In the example shown in FIG. 2, the environment 225 may be a room in a house. Although only one transmitter 210 is shown in one environment 225 is shown, it should be understood that the system 200 may include any number of transmitters, each to the transmitter 210 may be present in any number of environments, each to the environment 225. For example, the transmitter 210 may be a node in a mesh network, where multiple transmitters and receivers may be present. Other nodes may be present in other environments (e.g., other rooms) and communicate with the transmitter 210. Similarly, although only one receiver is shown in the environment 225, it should be understood that the system 200 may include any number of receivers in any number of environments. Thus, the system 200 may be configured to perform Wi-Fi sensing operations in a plurality of environments simultaneously.

The subject 220 may be a living organism that is capable of movement. In some examples, the subject 220 may be a human. In other examples, the subject 220 may be living organism, such as a pet. The subject 120 may be capable of motion. The subject 220 may alter one or more aspects of the wireless signals transmitted by the transmitter 220 due to motion and/or its presence within the environment 225 through which wireless signals propagate. The subject 220 may, through his or her presence, interact with the emitted wireless signals, creating characteristic alterations that may reflect the activity, identity, motion of, or other characteristic of the subject 220. Such alternations may represent various behaviors, such as for example, sitting up, standing, laying down, walking, or smaller motions such as hand gestures. The subject 220 can perform a wide range of activities, from basic movements such as walking and running to more nuanced actions like typing, gesturing, or changes in posture. The capability of the system 200 to discern these varied activities may allow for monitoring and analysis, enabling applications that range from enhancing security protocols, generating alerts or notifications, or optimizing smart home settings based on the presence or activity of individuals.

Turning next to the transmitter 210, the receiver 215, and associated signals. The transmitter 210 may be any device that is capable of transmitting a wireless signal (e.g., the wireless signal 214). For example, the transmitter 210 may include Wi-Fi routers, Wi-Fi access points, Wi-Fi adapters, Wi-Fi repeaters, or mesh network routers. The transmitter 210 may be a router such as a Wi-Fi router, used to provide a wireless local area network (or other such network) within the environment 225. The receiver 215 may be any device capable of receiving wireless signals (e.g., a modified wireless signal 216) and processing the received wireless signal. For example, the receiver 230 may similarly be a Wi-Fi router, a Wi-Fi adapter, a Wi-Fi repeater, a mesh network router, a set-top box (e.g., a television receiver), and/or a user device (e.g., a cellular phone, a laptop, etc.).

The transmitter 210 may include both hardware and software components to achieve transmission of a wireless signal, including configuration of the signal, such as the frequency, bandwidth, modulation, or data transfer rate of the signal. Bandwidth my refer to the range of frequencies that the signal occupies. For example, Wi-Fi signals typically use channel widths of MH2, 40 MH2, 80 MHz, or even 160 MHz in some standards. Wider channels can carry more data, providing higher throughput.

In some examples, such as mesh network routers, each node within the mesh network may act as a transmitter. The transmitter 210 may include circuitry capable of receiving digital instructions and converting those instructions to electric signals. This may include for example, a Radio Frequency (RF) front end, baseband processor (e.g., to handle modulation, error checking, and correction), and a microcontroller. Electrical signals can be provided from circuitry to an antenna that can convert the information into electromagnetic waves (e.g., a wireless signal 214). The transmitter 210 may include other capability or communication interfaces (e.g., ethernet, Bluetooth, NFC, etc.) to allow the transmitter to communication with one or other devices. For example, the transmitter 210 may be a set top box, that may have a co-axial connection to receive signals to provide internet access as well as a Bluetooth connection to receive input from one or more user devices. In some examples, the transmitter 210 may have multiple transmission antennas and/or other physical structures to support various capabilities of Wi-Fi signal transmission, such as for example, the Institute of Electrical and Electronics Engineers (IEEE) 802.11 standard.

Multiple modes of propagation may also be possible, such as for example, multiple input multiple output (MIMO) communication may be possible. Transmitter 210 may include the capabilities of data encoding, modulation techniques (e.g., Quadrature Amplitude Modulation (QAM) or Orthogonal Frequency-Division Multiplexing (OFDM), to encode digital data into radio waves), digital to analog conversion through modulation techniques to transmit data via radio waves over antennas, use of specific frequency bands and channels, and transmission of modulated radio signals. Transmitter 210 may also include the ability to demodulate received signals and error correction techniques to ensure that transmissions are reduced in error. A person of skill in the art will appreciate these and other techniques.

The transmitter 210 and the receiver 215 may both contain a Medium Access Control (MAC) layer and a Physical Layer (PHY), such as those specified by the IEEE 802.11 standard. Additionally, or alternatively, the transmitter 210 may be an emitter dedicated to Wi-Fi sensing applications. The transmitter 210 may be configured to transmit wireless signals via one or more wireless protocols, such as Wi-Fi, Zigbee, Bluetooth, and/or any other such wireless protocols.

Modulation may refer to a format in which data is encoded into radio waves or wireless waves. For example, modulation schemes may include PSK (phase shift keying), Binary Phase Shift Keying (BPSK), Quadrature Phase Shift Keying (QPSK), Quadrature Amplitude Modulation (QAM). Each modulation scheme determines how data is encoded into radio waves and impacts the data rate and robustness of the signal. BPSK may refer to using two phases to represent binary values, QPSK may refer to the use of four distinct phase shifts to represent data which are 90 degrees shifted from one another, where each phase shift carries two bits of information (e.g., (00, 01, 10, 11)). QAM effectively combines aspects of both amplitude modulation (AM) and phase modulation (PM) to increase the bandwidth efficiency of a system.

The transmitter 210 may transmit a wireless signal 214. The wireless signal 214 may be transmitted in all directions within the environment 225. In the example shown in FIG. 2E, multiple lines are illustrated for the wireless signal 224 to illustrate that the signals may be transmitted in multiple directions. Certain signals may be reflected or bounced off walls or other surfaces of the environment 225 prior to reaching the receiver 215. Some wireless signals may reach the receiver 215 directly. Although various paths for a signal are illustrated as dotted lines in FIG. 2E, it should be understood that signals propagate in both time and space. Thus, an environment 225, may have a complex pattern of scattering, reflection, refraction, etc. that may be considered by the receiver 215 in interpreting signals received.

The transmitter 210 may also transmit pilot signals or other reference signals to help determine channel state information (CSI). CSI may refer to known channel properties of a communication link. Channel state information (CSI) may be basically calculated using the pilot signals used during transmission by the transmitter 210 and compared with the received pilot signals at the receiver 215. Other metrics, such as signal to noise ratio (SNR) may indicate the strength of the transmitted signal with respect to the channel noise. CSI information may describe describes how a signal propagates from the transmitter to the receiver and represents the combined effect of, for example, scattering, fading, and power decay with distance. In some examples, CSI information may include signal to noise ratio, signal strength, interference levels, a channel matrix, channel coefficients (that may represent a channel's amplitude and phase shifts introduced on a particular channel, and fading characteristics of a specific channel), spatial information, a channel matrix, a channel estimation error, or other time-varying characteristics.

In some examples, CSI can be determined both by the transmitter 210 and the receiver 215. In some examples, the CSI can be determined using specialized algorithms, including machine learning algorithms such as neural networks. CSI information may also be used by the receiver 215 to “filter out” certain types of data prior to providing to a classification (e.g., a rule based on settings or other criteria determined by the receiver 215.

The transmitter 210 may be configured to generate more than one type of wireless signal at a time. For example, the transmitter may be capable of generating two wireless signals, such as a 2.4 GhZ wireless signal and a 5 GhZ wireless signal. This may be the case in a “dual-band” transmitter, that can simultaneously generate wireless signals at two frequencies. For example, the IEEE 802.11ac wireless networking standard set of protocols may be met by the transmitter, that may provide signals on the 5 GHz band. The generation of the wireless signal may also include the generation of a wireless local area network. The wireless local area network may include multiple bands or frequencies for simultaneous signal propagation. Each frequency of wireless signal may have different properties with respect to reflectivity, range, physical propagation, transmittivity, etc.

Aspects of the wireless signals and related physics are discussed in further detail below.

The wireless signal 214 and the modified wireless signal 216 are discussed below. The wireless signal 214 may be a signal that is configured to meet a particular standard, such as for example, the IEEE 802.11 standard. The wireless signal 214 may be a Wi-Fi signal. The wireless signal may include information such as modulation, encoding, amplitude, phase, and/or frequency.

The wireless signal 214 may be an electromagnetic wave (e.g., a wireless signal, a Wi-Fi signals, or other standard) that may be propagated through space in all directions from the transmitter 210. Although illustrated with a single line, a person of skill in the art will appreciate that the signal is propagated in throughout the environment 225, and may interact with one or more objects in the environment 225, including reflection from solid surfaces, walls, decor, or other objects in environment 225. Similarly, the interaction of the wireless signal 214 with the subject 220 may cause scattering, diffusion, or other physical phenomenon to occur that cause the modified wireless signal to be propagated in multiple directions, which make take independent paths prior to reaching the receiver 215. Thus, the wireless signal 214 may take multiple paths from the transmitter 210 to the receiver 215.

During propagation of the wireless signal 214, the wireless signal 214 may interact with the environment 225 and/or the subject 220. The interaction of the wireless signal 214 and the subject 220 may cause the wireless signal to vary or be modified from its original signal to contain new physical properties, such as for example, a phase shift, amplitude change, change in path, change in time taken to reach the receiver 215, etc. This interaction may produce the modified wireless signal 216. Comparison between the wireless signal 214 and the modified wireless signal 216 may be performed as part of determining a behavior of an object.

The wireless signal 214 and the modified wireless signal 216 may include or contain within them information related to multiple signal characteristics—e.g., amplitude, frequency, phase, and encoding-altered by the presence of the subject 220. These alterations may occur due to various physical phenomena such as reflection, diffraction, scattering, and absorption when a subject interacts with the signal path. For example, a moving subject might cause fluctuating signal strength, indicative of distance changes from the source, or phase shifts that suggest movement direction or speed. Such signal modifications provide a dataset from which the receiver 230 can extract patterns correlating with specific types of activities, motions, or events. This detailed analysis of altered signals may enable monitoring and classification of subjects or objects within the environment 225. Amplitude data and phase data may be CSI based amplitude data and CSI based phase data, respectively. This information may be analyzed.

FIG. 2F illustrates an exemplary embodiment of system 200 with multiple transmitters located in multiple environments. The components labeled with respect to FIG. 2F may be similar to the respective reference numerals illustrated in FIG. 2E. For clarity, not all signals, communications, and/or connections between components are illustrated.

Illustrated in the exemplary embodiment of system 200 are transmitters 210A, 210B, and 210C and the computing system 202. The transmitters 210A-210C may be similar to the transmitter 210 described above. Each transmitter may transmit a respective wireless signal (the transmitter 210A may transmit a wireless signal 214A in an environment 225A, the transmitter 210B may transmit a wireless signal 214B in an environment 225A, the transmitter 210C may transmit a wireless signal 214C in an environment 225C,) that may be modified by a respective subject 220A-220C. Subject 220A may alter the wireless signal 214A to form wireless signal 216A, that may be received by the transmitter 210B and the computing system 202. The subject 220A may also alter the wireless signal 214B to form the wireless signal 216B. Subject 220B may be too small, in a dead-zone, or not performing any activity which causes an alteration of the wireless signals. Subject 220C may modify the wireless signal 214C to form wireless signal 216C. The wireless signal 216C may be received by the transmitter 210C and the computing system 202.

In some examples, the subjects 220A-220C may include non-biological devices that may help identify the subject. For example, a dog collar may include a device that may interact with the wireless signals and identify the subject as being a dog. Similarly, other devices may be worn by a human (e.g., a smart watch, smart watches, a cell phone, etc.). In this manner, the computing system 202 may identify the specific subject for which behavior is being classified. This information may be used by the computing system 202 to choose an appropriate MLM to perform analysis. This identify of the subject may also be used by the rules based filter 273 to determine whether analysis should be performed or not. For example, analysis may not be performed when a subject is entering a particular environment (e.g., a dog entering a bathroom environment). Similarly, analysis may be performed when a subject is entering a particular environment (e.g., performing analysis to determine if a dog is sleeping in a bedroom, or is agitated within the bedroom environment). This information may be used in modifying the output 280 and/or the alert 290 to be more meaningful and contextually rich to a user.

The transmitter 210A and the transmitter 210C are illustrated to be in data communication with one another. The transmitters 210A-210C may form a mesh wireless network or a portion thereof. Further, the transmitters 210A-210C may be in data communication with the computing system 202.

The computing system 202 may receive the modified wireless signals 216A-216C, along with information regarding their respective transmitter sources (e.g., which environment the transmitters are located in). The computing system 202 may perform classifications for one or more of the wireless signals it receives to output a category of the subject and/or the category of the behavior. For example, the computing system 202 may use both the modified wireless signals 216A and 216B to classify the behavior of subject 220A. Similarly, the computing system 202 may use the modified signal 216C to characterize the behavior of the subject 220C. The respective environment in which the signals are obtained may also be utilized to modify how the classification and/or analysis of the signals is performed. Further, the output of the analysis may be modified based on the respective environment from which the wireless signal is obtained.

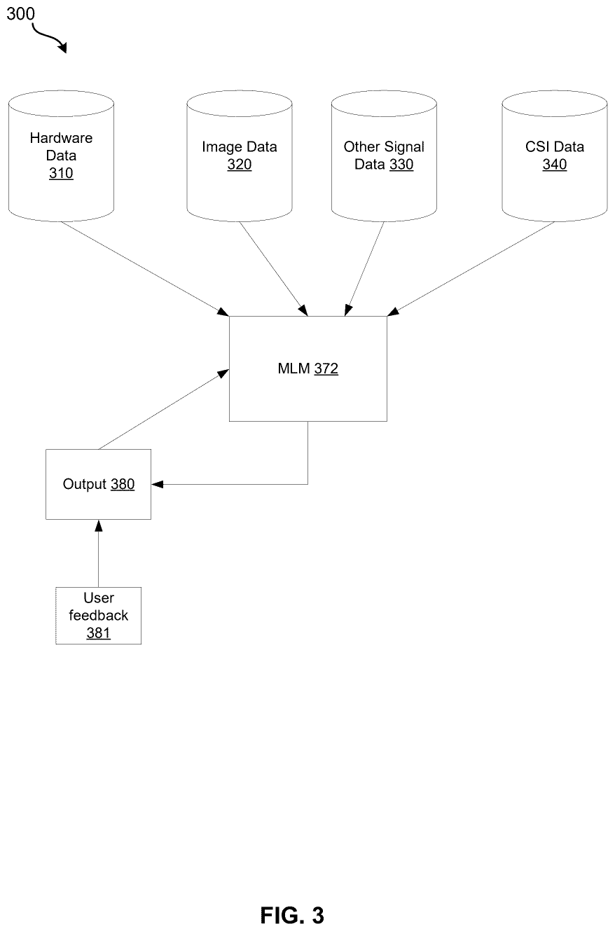

FIG. 3 illustrates training of one or more machine learning models (MLMs) according to example embodiments of the disclosed technology. Illustrated in FIG. 3 is system 300. System 300 has a number of datasets that may be used for training a machine learning model 372, such as hardware data 310, image data 320, other signal data 330, and CSI data 340. The machine learning module 372 may be similar to the machine learning module 272. Each of the datasets may also have data that is related or connected to a time value, allowing data from different datasets to be cross-referenced or used in the training process.

The hardware data 310 may include information related to the physical transmission and/or receipt of a wireless signal, including sensors, receivers, transmitters, antennas, make, model, known operational parameters, etc. The hardware data 310 may include information about a transmitter. For example, the transmitter may have various characteristics, operational parameters, performance parameters, configuration modes, etc., that may affect the transmission and reception of wireless signals. The information at hardware data 310 may be linked or used to train the MLM. Thus, the MLM may be able to identify information about the transmitter to better analyze signal data that is received by a receiver. In some examples, the hardware data 310 can be classified into one or more types of hardware for a wireless signal, such as a primary node, an ancillary node, etc. The hardware data can also include specific information regarding interference, processing used, modulation, and/or frequency of a transmitted or received wireless signal.

The image data 320 may be include one or more scalograms on which a machine learning model may be trained. Image data 320 may include information or metadata related to the image, such as the annotated with information regarding a classification, such as “sitting down,” “walking,” etc. The metadata related to a specific image or scalogram may be time information, how the image was generated (e.g., the type of CWT transform used or pre-processing (such as how aggressive the CWT transform is)), etc. Additional information may include whether the image was generated from an amplitude or phase component of a received wireless signal. These images may have been generated using an image generation module 250.

The other signal data 330 may include the type of environment, the background default of the environment (e.g., the long term average of the environment), the noisiness of the environment (e.g., RSSI, signal-to-noise ratio, packet loss rate), etc. Other information that may be included at this block may include received Signal Strength Indicator (RSSI), packet data, signal-to-noise ratio (SNR), angle of arrival, time of flight, etc. In some examples, the other signal data 330 may include for example “bad samples” can be used to train the machine learning model to detect and avoid classification of signals from which a classification is not possible.

Channel State Information (CSI) data 340 may include detailed data about the channel properties between the transmitter and receiver. For example, CSI information may have information of a transmitted or received signal which is broken down into carriers or individual subcarriers (small frequency bands). This may be the case in, for example, orthogonal frequency-division multiplexing (OFDM) systems.

A combined dataset may be generated based on the hardware data 310, the image data 320, and the signal data 330. The combined dataset may also be split into training, validation, and test sets, enabling the iterative refinement of the machine learning model. The training set may include preprocessing and labeling of the training dataset may occur. In the training set, only a subset of data that is useful or of a certain criterion suitable for training may be used to ensure a high-quality training set. A validation dataset may be used to fine tune aspects of the model and to assess the performance of one or more trained MLMs. One or more metrics related to the machine learning models performance may be improved. This process may take place iteratively. In some examples, the model parameters may be adjusted or the choice of training algorithm may be changed. The test dataset may be used to test the model to evaluate its performance (e.g., accuracy, number of false positives, the use of a confusion matrix, etc.).

The output 380 may be similar to the output 280 and be a classification or other output provided by the machine learning model. As one example, the output 380 may be a classification for a given input and the probability or confidence of that output. The output may be provided to a user to provide user feedback 381. The user feedback 381 may be part of the training process of the machine learning model. In some examples, the user feedback 381 may be used to update an MLM when the MLM is in the field or operational in an environment. This may allow the machine learning model to adjust for variances in a specific environment and/or for a specific subject.

In some examples, supervised learning models may be used. In this example, models may be trained on a labeled dataset. For instance, each training example for the machine learning model may be paired with an output label. In the training process, the model learns to predict an output from an input set of data. Examples may include linear regression for continuous outputs and logistic regression, support vector machines (SVMs), and neural networks for categorical outputs. Additional examples may include unsupervised learning models. Such models work with unlabeled data. Techniques that may be used include clustering (e.g., k-means, hierarchical clustering) and dimensionality reduction (e.g., principal component analysis, auto-encoders, etc.). Other examples may include semi-supervised learning processes. This involves a combination of a small amount of labeled data and a large amount of unlabeled data. The model leverages the labeled data to learn better representations of the unlabeled data, improving its performance.

In some examples, reinforcement learning techniques may be used. In some examples, models may be trained or “learn” to make sequences of decisions by interacting with an environment to achieve a goal. The learning is guided by rewards, where the model seeks to maximize its total reward. Examples include game playing, robotic navigation, and online recommendation systems.

In some examples, additional types of machine learning models, techniques, or training methods may be used. In some examples, a Recurrent Neural Network (RNN) may be used. A Recurrent Neural Network (RNN) is a class of artificial neural networks where connections between nodes form a directed graph along a temporal sequence. This structure allows RNNs to exhibit temporal dynamic behavior and to process sequences of inputs. This makes them particularly suitable for applications where the time aspect of data is useful. RNN architecture involves a layer of neurons that are connected in a loop, allowing information to persist. Variants of the RNN network, including Long Short-Term Memory (LSTM) may be used. LSTM is designed to overcome a problem of a vanishing gradient in RNNs and is capable of achieving learning long-term dependencies. Gated Recurrent Units, that are a simplified version of LSTMs may also be used. GRUs use a different gating mechanism than LSTMs and are effective at capturing long-term dependencies. Convolutional Neural Networks (CNNs) are a specialized kind of Deep Neural Networks. CNNs are composed of multiple layers that transform the input volume (such as an image) into an output volume (e.g., class scores) through a series of differentiable operations.

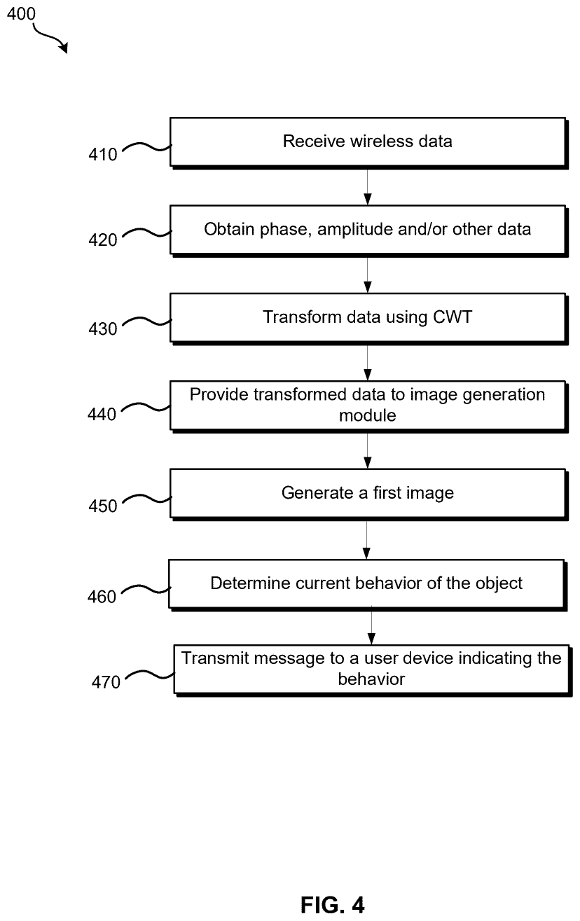

FIG. 4 illustrates a flowchart of a method 400 for detecting objects within an environment, according to certain embodiments. The method 400 may be performed by some or all of the systems and devices described herein. For example, the method 400 may be performed by the systems 100 and/or 200, working alone or in conjunction with each other. The steps of the method 400 may be performed in a different order than is shown and described, and/or some steps may be combined. In some embodiments, some steps may be skipped altogether.

At step 410, the method 400 may include, receiving, a wireless data by a computing system. The wireless data may be the wireless data 230, the wireless signal 214, or the modified wireless signal 216. The wireless data may be received by a wireless circuitry that may be similar to the wireless circuitry 240 of FIG. 2A. The wireless signals received may be emitted from a transmitter and received at the receiver. The wireless signals received may include or contain within them information related to multiple signal characteristics—e.g., amplitude, frequency, phase, and encoding-altered by the presence of a subject within an environment. These alterations may occur due to various physical phenomena such as reflection, diffraction, scattering, and absorption when a subject interacts with the signal path. For example, a moving subject might cause fluctuating signal strength, indicative of distance changes from the source, or phase shifts that suggest movement direction or speed. Such signal modifications provide a dataset from which the receiver can extract patterns correlating with specific types of activities, motions, or events. This analysis of altered signals may enable monitoring and classification of subjects or objects within an environment. In some examples, the wireless data 230 may be received by the computing system 202, which may act as a central node for a mesh wireless network

At step 420, the method 400 may include determining and/or obtaining, by the computing system and/or the wireless circuitry of the receiver, at least one of phase information or amplitude information associated with the wireless data. For example, the wireless circuitry of the receiver may generate amplitude information and/or phase information, and additionally, other data and/or information. Such data may be generated in a digital or analog format. The amplitude information may include information of the amplitude of one or more received signals over time. The phase information may include information related to the phase of one or more received signals over time. Other information and/or data may include other information related to encoding, transmission source, and/or transmission standard. The wireless circuitry may also distinguish between one or more of the signals received. For example, wireless circuitry may distinguish between the modified wireless signal 216 and a wireless signal 214.

As another example, the wireless data 230 may include information which already includes processed amplitude, phase information, and/or location information. The wireless data 230 may be obtained from another node of the mesh wireless network. The wireless data 230 may identify the environment from which the wireless data 230 is obtained. In some examples, the wireless data 230 may contain all of the wireless signals/and or data in the network which may be provided to a central node for analysis (e.g., the computing system 202).

At step 430, the method 400 may include generating, by the receiver using continuous wavelet transformation, at least one of phase data or amplitude data based on the phase information or the amplitude information, respectively. For example, a Continuous Wavelet Transform (CWT) module (e.g., similar to the CWT module 246)) may process signals using wavelet transforms to analyze different frequency components at various scales. This module may identify and isolate specific features within a signal. In some examples, the CWT module 246 may process analog data (e.g., the wireless signal before the ADC). In some examples, the CWT module 246 may process digital data (e.g., data after conversion into a digital format by ADC 244). The CWT model may thus transform the phase information and/or the amplitude information.

At step 440, the method 400 may include providing, by the wireless circuitry of the receiver, at least one of the phase data or the amplitude data to an image generation module executed by the receiver. The image generation module of the receiver may be similar to the image generation module 250 of the computing system 202. The image generation module may include hardware and/or software which is capable of generating images based on information of data obtained from the wireless circuitry. For example, the image generation module may contain the capability to generate one or more visual representations of wireless data. For example, image generation module is able to represent information related to one or more wireless signals as a scalogram. A scalogram is a visual representation of a signal's frequency content over time, created using wavelet transforms. In some examples, the image generation module can provide information which can relate to its output, such as the inability to produce an image based on the information which has been received by the image generation module.

At step 450, the method 400 may include processing, by the image generation module executed by the computing system, at least one of the phase data or the amplitude data to generate a first image of the environment. The first image of the environment may contain aspects of a signal modified due to activity and/or the presence of a subject. For example, the image generation module is able to represent information related to one or more wireless signals as a scalogram. A scalogram is a visual representation of a signal's frequency content over time, created using wavelet transforms. In some examples, the image generation module can provide information which can relate to its output, such as the inability to produce an image based on the information which has been received by the image generation module. The image may be similar the image 260 or the images 260A-260D. In some examples, additional or second images may be generated which may confirm and/or provide points of comparison for the behavior of the object.

At step 460, the method 400 may include detecting, by the computing system and based on the image, the object within the environment. The detection of an object within the environment may include detecting activity and/or motion of a subject within the environment. The detection may also include classification of a subject and/or activity of the subject. For example, a classification module (e.g., similar to the classification module 170 or the classification module 270) may detect one or more characteristics included in an image, including for example, the detection of activity, gestures, or motion of a subject. For example, the image 260 may contain characteristics representing changes over time in the modified wireless signal. The classification module may classify these characteristics in order to detect object, an activity, motion, gestures, etc. The image may be a scalogram obtained based on outputs of wireless circuitry. The classification module may classify the scalogram into one of several outputs. Additional aspects of the classification module and classification techniques are discussed herein, The classification may be provided as an output (e.g., similar to the message 190, output 280, the outputs 280A-280D, or the alert 290).

At step 470, the method 400 may include transmitting, from the computing system to a user device, a message to a user device. The message may indicate a first current behavior of the object. The message may be similar to the message 190 or the alert 290. The user device may be similar to the user device 192.

In various embodiments, the computer system may receive a request from a user device for a current behavior of an object. The computing system and/or mesh network may determine a particular device (e.g., transmitter) which is closest to the object at a given time and/or within a given proximity to the object. The determined particular device may be utilized to perform the classifications. In some examples, the location of the object may be determined based on the node of the computing system in which perturbations to the wireless signal are detected. The object may thus be localized based on the node in which the wireless signal is determined to be modified and/or altered.

The computer system may further generate multiple classifications (e.g., a first current behavior, a second current behavior) based on the multiple images. Each classification may have a confidence metric associated with the classification. The confidence metric may be compared to a pre-determined threshold to determine if the classification(s) are correct. If so, then the computer system may generate a message to a user indicating the behavior/classification. In this manner, the classification may be said to have a higher probability based on the joint confidence metrics. The wireless data for each respective image may be from the same transmitter (e.g., using two frequencies, using two components of the wireless signal (e.g., phase, amplitude)) or from two different transmitters.

In various embodiments, the computing system performing the classification may be a central node. Satellite nodes may be transmitting and/or receiving wireless signals (that may be used to generate the scalograms). The satellite nodes may perform the CWT transforms, obtain coefficients, generate scalograms (or data used to generate the scalograms), and provide any of this information to the central node. Each satellite node may be configured to generate image data based on the respective wireless data it receives. Each satellite node may comprise a respective image generator and/or respective machine learning module, which may be used to perform classifications.

In various embodiments, a specific machine learning model can be selected or chosen for classification depending on the environment, the number of transmitters or receivers, the noisiness of the environment, the model of the transmitter or receiver etc. For example, a lightweight or edge AI model may be used. An edge AI model may be a model which is executed only on the receiver, and does not communicate with a server. In some examples, other protocols can be run to “zero-out” the environment during times in which the environment may be considered to be inactive (e.g., at 3 am in the morning). This may allow for variations in the environment to be removed, such as change in the furniture. This background effect may be removed when generating or analyzing signals to better account for the effect the subject has on changing the wireless signal. Other MLMs or settings may be chosen based on user input (e.g., if the user indicates that he has young children and/or pets).

In various embodiments, classification can occur twice from the same signal. For example, amplitude information of a received signal can be used to create a first classification, and the phase information of a received signal can be to produce a second classification. The first classification and the second classification can be used to verify one another and reduce the number of false positives. Thus, with the same information (e.g., the same received wireless signal), and at the same time, transient information can be used to produce two classifications of the same signal, which can be used to increase the accuracy of a classification.

For example, the amplitude information can generate a first image while the phase information can generate a second image. Each image can be analyzed by a separate classification module. One classification module may contain a MLM which is only configured to analyze amplitude data while the other classification module may contain an MLM which is only configured to analyze phase data. Each classification module may generate a separate classification. The classifications may be checked against one another.

In various embodiments, the machine learning model, or other control module, may control and/or influence the strength of signal processing, such as the level of filtering, or the nature of the CWT model used.

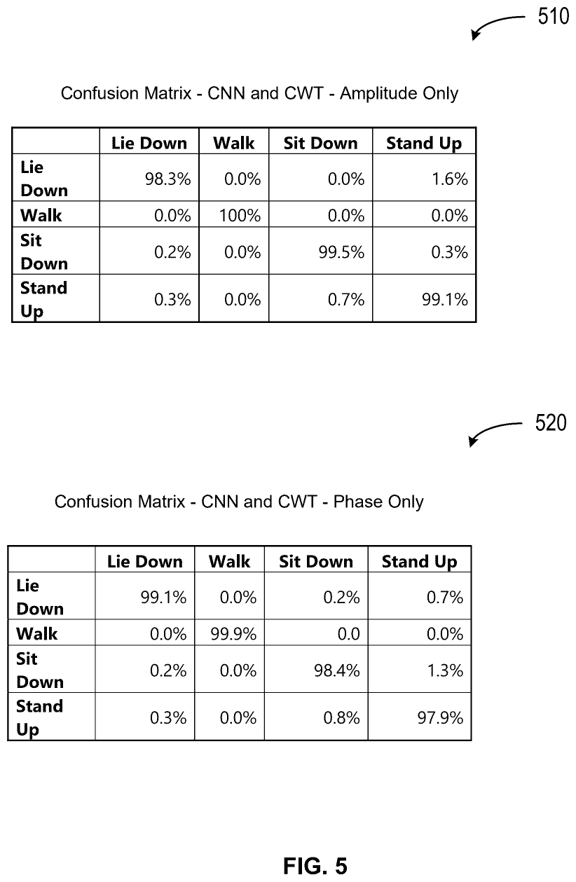

FIG. 5 illustrates various experimental results gathered using a CNN and CWT transformations on Wi-Fi sensing data, according to certain embodiments. The machine learning model used to analyze the data is based on CNN LeNet-5 and uses CWT to remove the noise from CSI data. FIG. 5 illustrates tables 510 and 520. Table 510 may show classifications made using only amplitude data. Only phase data is used to make classifications for table 520. The four tasks which are detected for a subject are—“lie down,” “walk,” “sit down,” and “stand up.” For these results, CSI amplitude data or CSI phase data is transformed using CWT transformation, The CWT co-efficient was fed to a CNN LeNET-5 model. These results show the improvement of the techniques in outperforming existing techniques, with a minimum accuracy of around 98%. This illustrates how a CWT transformation helps to reduce noise and how a LeNET-5 model can classify the data with high accuracy.

FIG. 6 is a schematic diagram illustrating an example of computer system 600. The computer system 600 is a simplified computer system that can be used to implement various embodiments described and illustrated herein. A computer system 600 as illustrated in FIG. 6 may be incorporated into devices such as a portable electronic device, mobile phone, or other device as described herein. FIG. 6 provides a schematic illustration of one embodiment of a computer system 600 that can perform some or all of the steps of the methods and workflows provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown including hardware elements that can be electrically coupled via a bus 605, or may otherwise be in communication, as appropriate. The hardware elements may include one or more processors 610, including without limitation one or more general-purpose processors and/or one or more special-purpose processors such as digital signal processing chips, graphics acceleration processors, and/or the like; one or more input devices 615, which can include without limitation a mouse, a keyboard, a camera, and/or the like; and one or more output devices 620, which can include without limitation a display device, a printer, and/or the like.

The computer system 600 may further include and/or be in communication with one or more non-transitory storage devices 625, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 600 might also include a communications subsystem 660, which can include without limitation a modem, a network card (wireless or wired), an infrared communication device, a wireless communication device, and/or a chipset such as a Bluetooth™ device, a 802.11 device, a Wi-Fi device, a Wi-Max device, cellular communication facilities, etc., and/or the like. The communications subsystem 630 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 630. In other embodiments, a portable electronic device, e.g., the first electronic device, may be incorporated into the computer system 600, e.g., an electronic device as an input device 615. In some embodiments, the computer system 600 will further include a working memory 635, which can include a RAM or ROM device, as described above.

The computer system 600 also can include software elements, shown as being currently located within the working memory 635, including an operating system 660, device drivers, executable libraries, and/or other code, such as one or more application programs 665, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 6, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 625 described above. In some cases, the storage medium might be incorporated within a computer system, such as computer system 600. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 600 and/or might take the form of source and/or installable code, which, upon compilation and/or installation on the computer system 600 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 600 to perform methods in accordance with various embodiments of the technology. According to a set of embodiments, some or all of the operations of such methods are performed by the computer system 600 in response to processor 610 executing one or more sequences of one or more instructions, which might be incorporated into the operating system 660 and/or other code, such as an application program 665, contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 625. Volatile media include, without limitation, dynamic memory, such as the working memory 635.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 630 and/or components thereof generally will receive signals, and the bus 605 then might carry the signals and/or the data, instructions, etc. carried by the signals to the working memory 635, from which the processor(s) 610 retrieves and executes the instructions. The instructions received by the working memory 635 may optionally be stored on a non-transitory storage device 625 either before or after execution by the processor(s) 610.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A system comprising:
an image generation module;
a machine learning module;
one or more processors; and
a non-transitory computer readable medium comprising instructions that, when executed by the one or more processors, cause the system to perform operations to
receive, by a computing system, wireless data comprising phase data and amplitude data over a time period;
generate, by an image generation module of a computing system, a first image using at least one of the phase data or the amplitude data of the wireless data, wherein the first image represents an object during the time period;
determine, by a machine learning module implemented on the computing system, a first current behavior of the object based on the first image; and
transmit, by the computing system, a message to a user device, the message indicating the first current behavior of the object.

2. The system of claim 1, further comprising:
one or more satellite nodes, each configured to transmit and/or collect wireless data; and
a central node, the central node configured to receive the wireless data from the one or more satellite nodes, and wherein the machine learning module is implemented on the central node.

3. The system of claim 2, wherein each of the one or more satellite nodes is configured to generate image data based on respective wireless data received at the one or more satellite nodes.

4. The system of claim 1, further comprising:
one or more satellite nodes, each configured to transmit and/or collect wireless data, and wherein each of the satellite nodes comprises a respective image generator and respective machine learning module.

5. The system of claim 1, wherein the machine learning module comprises at least one of a K-Nearest Neighbor model, a clustering model, and a computer vision model.

6. The system of claim 1, wherein the image generation module utilizes continuous wavelet transformation.

7. A method for detecting behaviors, the method comprising:
receiving, by a computing system, wireless data comprising phase data and amplitude data over a time period;
generating, by an image generation module of a computing system, a first image using at least one of the phase data or the amplitude data of the wireless data, wherein the first image represents an object during the time period;
determining, by a machine learning module implemented on the computing system, a first current behavior of the object based on the first image; and
transmitting, by the computing system, a message to a user device, the message indicating the first current behavior of the object.

8. The method of claim 7 wherein the first current behavior of the object is at least one of one of sitting, standing, walking, running, moving, laying down.

9. The method of claim 7, further comprising applying a continuous wavelet transformation to the wireless data.

10. The method of claim 7, further comprising:
receiving, by the computing system and from the user device, a request for the first current behavior of the object; and
determining, by the computing system, a particular device of the computing system within a given proximity of the object.

11. The method of claim 7, further comprising:
determining, by the computing system, that the first current behavior is an unwanted behavior; and
transmitting, by the computing system, an emergency message to an emergency service.

12. The method of claim 11 further comprising:
determining, by the computing system, a location of the object based at least in part on a node of the computing system.

13. The method of claim 7, further comprising:
receiving, by the computing system, additional wireless data comprising phase data or amplitude data over the time period;
generating, by the image generation module of the computing system, a second image using at least one of the phase data or the amplitude data of the additional wireless data, wherein the second image represents the object during the time period;
determining, by the machine learning module implemented on the computing system, a second current behavior of the object based on the second image; and
comparing, by the computing system, the first current behavior and the second current behavior to generate a confidence metric.

14. The method of claim 13 wherein the wireless data corresponds to a first frequency and the additional wireless data corresponds to a second frequency.

15. The method of claim 7, further comprising:
generating, by the image generation module of the computing system, a second image using unused data of at least one of the phase data or the amplitude data of the wireless data, wherein the second image represents the object during the time period;
determining, by the machine learning module implemented on the computing system, a second current behavior of the object based on the second image; and
comparing, by the computing system, the first current behavior and the second current behavior to generate a confidence metric.

16. The method of claim 15 wherein the message is transmitted to the user device in response to the confidence metric being over a predetermined threshold.

17. The method of claim 7, further comprising:
providing, by the computing system, one or more data sets comprising phase data and/or amplitude data corresponding to one or more particular behaviors to the machine learning module; and
causing, by the computing system, one or more machine learning models of the machine learning module to be retrained using the one or more data sets.

18. A computer-readable medium containing instructions that, when executed by one or more processors, cause the one or more processors to perform operations comprising:
receiving, by a computing system, wireless data comprising phase data and amplitude data over a time period;
generating, by an image generation module of a computing system, a first image using at least one of the phase data or the amplitude data of the wireless data, wherein the first image represents an object during the time period;
determining, by a machine learning module implemented on the computing system, a first current behavior of the object based on the first image; and
transmitting, by the computing system, a message to a user device, the message indicating the first current behavior of the object.

19. The computer-readable medium of claim 18, wherein the image generation module utilizes continuous wavelet transformation.

20. The computer-readable medium containing instructions of claim 18, the operations further comprising:
receiving, by the computing system, additional wireless data comprising phase data or amplitude data over the time period;
generating, by the image generation module of the computing system, a second image using at least one of the phase data or the amplitude data of the additional wireless data, wherein the second image represents the object during the time period;
determining, by the machine learning module, a second current behavior of the object based on the second image; and
comparing, by the computing system, the first current behavior and the second current behavior to generate a confidence metric.
